(19) United States
(12) Patent Application Publication
(10) Pub. No.: US 2004/0086129 A1
(43) Pub. Date: May 6, 2004

(54) Method of reproducing multichannel audio sound via several real and at least one virtual speaker

(76) Inventors: Daniel Willem Elisabeth Schobben, Eindhoven (NL); Paulus Maria Boers, Eindhoven (NL)

Correspondence Address: Edward D Goodman, US Philips Corporation, Intellectual Property Department, PO Box 3001, Briarcliff Manor, NY, 10510, US

(21) Appl. No.: 10/472,424

(22) PCT Filed: Mar. 15, 2002
(86) PCT No.: PCT/IB02/00864

(30) Foreign Application Priority Data
Mar. 22, 2001 (EP) 01201076.5

(51) Int. Cl. H04R 5/00; H04R 5/02

(52) U.S. Cl. 381/18; 381/19; 381/310

(57) ABSTRACT

The invention relates to a method of reproducing multichannel audio sound via several real and at least one virtual speaker (2, 3, 4, 5, 6, 9, and 10). According to the invention, the audio sound envisaged for a real speaker (2, 3, 4, 5, and 6) is reproduced partly via the real speaker (2, 3, 4, 5, and 6) and partly via a virtual speaker (9 and 10) positioned in the same location.

The invention relates to a method of reproducing multichannel audio sound via several real and at least one virtual speaker.

U.S. Pat. No. 5,742,687 discloses a process for a stereo signal in which a filtered left stereo signal is supplied to the left speaker of a stereo system and a filtered right stereo signal to the right speaker of the stereo system. Phase differences lead to an expansion of the stereo image. Sound waves reach the two ears of a listener sitting in a room with a multichannel speaker arrangement. Such a multichannel sound reproduction system has a relatively small pleasant sound spot. The pleasant sound spot is the area in which the listener perceives an optimum sound field. The perceptible sound field deteriorates when the listener moves away from the pleasant sound field. Also the perceptible sound field deteriorates if several listeners are present or if the multichannel speaker system is not optimally positioned. Problems arise in particular if the listener is positioned too close to one of the surround sound speakers. This speaker then becomes dominant, which has a disruptive effect on the listener.

The invention has for its object to avoid disruption for a listener. In particular the pleasant sound field is to be enlarged.

This object is achieved by the features of claim 1. According to the invention, the audio sound envisaged for a real speaker is reproduced partly via the real speaker and partly via a virtual speaker placed in the same location. A virtual speaker arranged in the location of a real speaker is simulated by filtration of audio signals and it is realized through the use of speakers other than the one which is simulated. If a listener now approaches a speaker, the contribution of the real speaker increases. Part of this speaker signal, however, is reproduced by a virtual speaker placed in the same location through the action of other speakers. The listener moves away from the other speakers as he approaches the individual real speaker, and the virtual speaker will fade out. In this way the perceived sound intensity of the combined real and virtual speakers is held approximately constant.

The process may be applied to all audio products which have multichannel systems. Examples are televisions with surround sound and home cinemas.

For better understanding of the invention, an embodiment will be described below in more detail with reference to the drawing, in which:

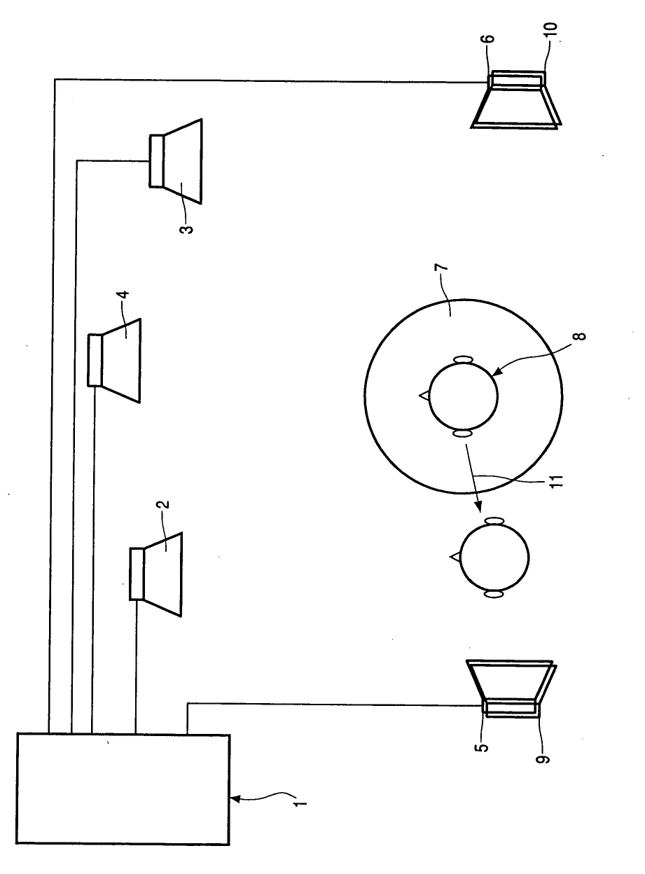

FIG. 1 shows a music system and a speaker arrangement with real and virtual speakers.

FIG. 1 shows a music system 1 with a left front speaker 2, a right front speaker 3, a central speaker 4, a left rear room speaker 5 and a right rear room speaker 6. The rear room speakers 5 and 6 produce a surround sound. The speakers 2 to 6 form a speaker arrangement, in the centre of which a pleasant sound space 7 is formed, also known as the sound spot, at which sound reproduction occurs. This speaker arrangement of speakers 2 to 6 also includes a deep bass speaker not shown in the drawing. The deep bass speaker produces sound down to 200 Hz, which cannot be localized. A listener 8 is present within the sound spot 7. Virtual speakers 9 and 10, referred to below as sound bodies or sound sources, are also arranged in the locations of the rear room speakers 5 and 6. If the listener 8 now moves in direction 11 from the pleasant sound spot 7 towards the sound bodies 5 and 9, he is moving away from the speakers 3 and 6 and approaching the speaker 5. The sound intensity of the virtual speaker 9 will decrease and the sound intensity of the real speaker 5 will increase.

Reference List:

1. Music system

2. Speaker

3. Speaker

4. Speaker

5. Speaker

6. Speaker

7. Sound spot

8. Listener

9. Sound body

10. Sound body

11. Direction

1. A method of reproducing multichannel audio sound via several real and at least one virtual speaker (2, 3, 4, 5, 6, 9, and 10), characterized in that the audio sound envisaged for a real speaker (2, 3, 4, 5, and 6) is reproduced partly via the real speaker (2, 3, 4, 5, and 6) and partly via a virtual speaker (9 and 10) positioned in the same location.

2. A music system (1) for the reproduction of multichannel audio sound, which system has several speakers (2, 3, 4, 5, 6, 9, and 10), characterized in that the audio sound provided for a real speaker (2, 3, 4, 5, and 6) is reproduced partly via the real speaker (2, 3, 4, 5, and 6) and partly via a virtual speaker (9 and 10) positioned in the same location.
